(19) United States
(12) Patent Application Publication
(10) Pub. No.: US 2022/0100630 A1
(43) Pub. Date: Mar. 31, 2022

(54) DATA PROCESSING SYSTEM, DATA PROCESSING METHOD, AND RECORDING MEDIUM HAVING DATA PROCESSING PROGRAM RECORDED THEREON

(71) Applicants: Yokogawa Electric Corporation, Tokyo (JP); Yokogawa Solution Service Corporation, Tokyo (JP)

(72) Inventor: Ryoichi HIMONO, Tokyo (JP)

(21) Appl. No.: 17/483,863

(22) Filed: Sep. 24, 2021

(30) Foreign Application Priority Data
Sep. 28, 2020 (JP) 2020-162714

(51) Int. Cl. G06F 11/34; G06F 16/28; G06F 11/30

(52) U.S. Cl. CPC G06F 11/3409; G06F 11/3013; G06F 16/285

(57) ABSTRACT

Provided is a data processing system comprising: an operation data acquisition unit configured to acquire operation data indicative of performance relating to an operation of production; an evaluation data acquisition unit configured to acquire evaluation data indicative of performance relating to an evaluation of the production; a standard storage unit configured to store each management standard to be complied with for a target management parameter; a data classification unit configured to classify performance data indicative of performance of the production, based on a determination result obtained by determining whether the operation data complies with the management standard for the management parameter, and the evaluation data; and an output unit configured to output a classification result.

The contents of the following Japanese patent application are incorporated herein by reference:

NO. 2020-162714 filed in JP on Sep. 28, 2020

### BACKGROUND

### 1. Technical Field

The present invention relates to a data processing system, a data processing method, and a recording medium having a data processing program recorded thereon.

### 2. Related Art

Patent Document 1 discloses ‘a manufacturing analysis method for specifying a hindering factor that causes a variation in product performance and for stabilizing product performance.

### PRIOR ART DOCUMENT

### [Patent Document]

Patent Document 1: Japanese Patent Application Publication No. 2016-177794

### SUMMARY

(Item 1)

A first aspect of the present invention provides a data processing system. The data processing system may comprise an operation data acquisition unit configured to acquire operation data indicative of performance relating to an operation of production. The data processing system may comprise an evaluation data acquisition unit configured to acquire evaluation data indicative of performance relating to an evaluation of the production. The data processing system may comprise a standard storage unit configured to store each management standard to be complied with for a target management parameter. The data processing system may comprise a data classification unit configured to classify performance data indicative of performance of the production, based on a determination result obtained by determining whether the operation data complies with the management standard for the management parameter, and the evaluation data. The data processing system may comprise an output unit configured to output a classification result.

(Item 2)

The data classification unit may be configured to classify the performance data into at least four, depending on whether the operation data complies with the management standard for all items relating to an operating parameter of the management parameter, and whether the evaluation data meets the predetermined standard.

(Item 3)

The output unit may be configured to output a display screen for displaying each frequency classified into the at least four, as a graph.

(Item 4)

The data classification unit may be configured to classify the performance data, depending on whether the evaluation data meets a predetermined standard, for each of a case where the operation data complies with the management standard, a case where the operation data deviates upward from the management standard and a case where the operation data deviates downward from the management standard, for each item of the management parameter.

(Item 5)

The output unit may be configured to output a display screen for displaying a frequency as to whether the evaluation data meets the predetermined standard for each case, for each item of the management parameter, as a graph.

(Item 6)

The output unit may be configured to output a display screen for showing an association as to which of the cases that data, in which the evaluation data does not meet the predetermined standard, of the performance data corresponds to, for each item of the management parameter.

(Item 7)

The output unit may be configured to output a display screen for showing an association as to which of the cases that data, in which the evaluation data meets the predetermined standard, of the performance data corresponds to, for each item of the management parameter.

(Item 8)

The data processing system may further comprise a standard update unit configured to update at least one of an evaluation standard for determining an evaluation index based on the evaluation data, or the management standard.

(Item 9)

The data classification unit may be configured to reclassify the performance data by using the standard after update, in response to the update of at least one of the evaluation standard and the management standard, or the output unit may be configured to output a reclassified classification result.

(Item 10)

The data processing system may further comprise an input unit configured to receive a user input, and the standard update unit may be configured to update at least one of the evaluation standard or the management standard, based on the user input.

(Item 11)

The data processing system may further comprise an update decision unit configured to decide an update of at least one of the evaluation standard or the management standard, according to the classification result, and the standard update unit may be configured to update at least one of the evaluation standard and the management standard, based on the decision of the update decision unit.

(Item 12)

The update decision unit may be configured to search for a combination in which the evaluation data highly frequently meets the predetermined standard, from combinations of each case for a plurality of items of the management parameter, and to decide the management standard after update.

(Item 13)

The evaluation data may include data obtained by evaluating a quality of a product to be produced.

(Item 14)

The evaluation data may include data obtained by evaluating at least one of productivity, cost, delivery or safety of the production.

(Item 15)

A second aspect of the present invention provides a data processing method. The data processing method may comprise acquiring operation data indicative of performance relating to an operation of production. The data processing method may comprise acquiring evaluation data indicative of performance relating to an evaluation of the production. The data processing method may comprise storing each management standard to be complied with for a target management parameter. The data processing method may comprise classifying performance data indicative of performance of the production, based on a determination result obtained by determining whether the operation data complies with the management standard for the management parameter, and the evaluation data. The data processing method may comprise outputting a classification result.

(Item 16)

A third aspect of the present invention provides a recording medium having a data processing program recorded thereon. The data processing program may be configured to be executed by a computer. The data processing program may be configured to cause the computer to function as an operation data acquisition unit configured to acquire operation data indicative of performance relating to an operation of production. The data processing program may be configured to cause the computer to function as an evaluation data acquisition unit configured to acquire evaluation data indicative of performance relating to an evaluation of the production. The data processing program may be configured to cause the computer to function as a standard storage unit configured to store each management standard to be complied with for a target management parameter. The data processing program may be configured to cause the computer to function as a data classification unit configured to classify performance data indicative of performance of the production, based on a determination result obtained by determining whether the operation data complies with the management standard for the management parameter, and the evaluation data. The data processing program may be configured to cause the computer to function as an output unit configured to output a classification result.

The summary clause does not necessarily describe all necessary features of the embodiments of the present invention. The present invention may also be a sub-combination of the features described above.

### BRIEF DESCRIPTION OF THE DRAWINGS

FIG. 1 shows an example of a block diagram of a data processing system 100 according to the present embodiment, together with a production management target 10.

FIG. 2 shows an example of a QM matrix that is stored by the data processing system 100 according to the present embodiment.

FIG. 3 shows an example of performance data that is recorded by the data processing system 100 according to the present embodiment.

FIG. 4 shows an example of a flow by which the data processing system 100 according to the present embodiment processes data.

FIG. 5 shows an example of a classification result that is output by the data processing system 100 according to the present embodiment.

FIG. 6 shows an example of another classification result that is output by the data processing system 100 according to the present embodiment.

FIG. 7 shows an example of another classification result that is output so as to support a finding of a deviation pattern by the data processing system 100 according to the present embodiment.

FIG. 8 shows an example of another classification result that is output so as to support a finding of a recovery method by the data processing system 100 according to the present embodiment.

FIG. 9 shows an example of a flow of updating an evaluation standard and a management standard by using the data processing system 100 according to the present embodiment.

FIG. 10 schematically shows an example of a change in classification result when an evaluation standard range is compressed using the data processing system 100 according to the present embodiment.

FIG. 11 schematically shows an example of the change in classification result when a management standard range is compressed using the data processing system 100 according to the present embodiment.

FIG. 12 schematically shows an example of the change in classification result when the QM matrix is set for each deviation pattern by using the data processing system 100 according to the present embodiment.

FIG. 13 shows an example of a block diagram of the data processing system 100 according to a modified embodiment of the present embodiment.

FIG. 14 shows an example of an analysis result when the data processing system 100 according to the modified embodiment of the present embodiment compresses the management standard range by using a decision tree analysis.

FIG. 15 shows an example of a computer 2200 in which a plurality of aspects of the present invention may be entirely or partially implemented.

### DESCRIPTION OF EXEMPLARY EMBODIMENTS

Hereinafter, the present invention will be described through embodiments of the invention. However, the following embodiments do not limit the invention defined in the claims. Also, all combinations of features described in the embodiments are not necessarily essential to solutions of the invention.

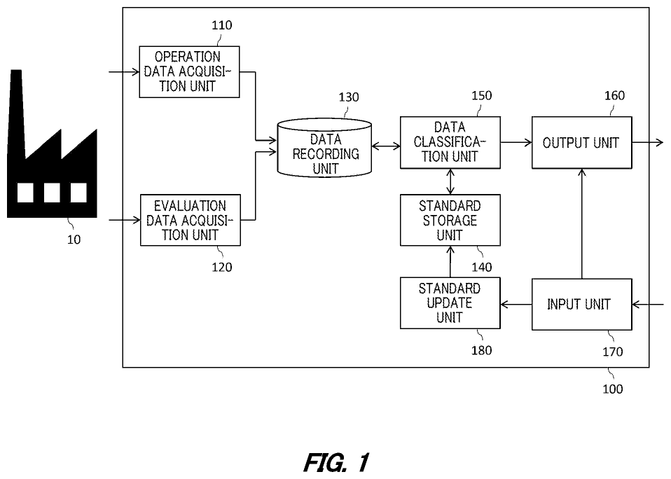

FIG. 1 shows an example of a block diagram of a data processing system 100 according to the present embodiment, together with a production management target 10. The data processing system 100 according to the present embodiment is configured to acquire and classify performance data indicative of performance of production in the production management target 10, and to output a classification result. At this time, the data processing system 100 according to the present embodiment is configured to classify the performance data, based on a result obtained by determining whether an operation in the production management target 10 complies with a management standard, and an evaluation of production in the production management target 10.

The production management target 10 is a target for which the data processing system 100 manages production. The production management target 10 may be, for example, a plant. The plant may include a plant for managing and controlling wells such as a gas field and an oilfield and surroundings thereof, a plant for managing and controlling hydroelectric, thermal electric, nuclear and the like power generations, a plant for managing and controlling environmental power generation such as solar power and wind power, a plant for managing and controlling water and sewerage, a dam and the like, in addition to a chemical industrial plant and the like. However, the present invention is not limited thereto. The data processing system 100 may set, as the management target, any industrial machine that produces a product by processing materials and the like.

The data processing system 100 may be a computer such as a PC (personal computer), a tablet-type computer, a smart phone, a workstation, a server computer, a general-purpose computer and the like, or a computer system where a plurality of computers is connected. This computer system is also a computer in a broad sense. The data processing system 100 may also be implemented by one or more virtual computer environment that can be executed in the computer. Instead of this, the data processing system 100 may be a dedicated computer designed for data processing or dedicated hardware implemented by dedicated circuitry. In a case where the data processing system 100 can connect to the Internet, the data processing system 100 may also be implemented by clouding computing.

The data processing system 100 comprises an operation data acquisition unit 110, an evaluation data acquisition unit 120, a data recording unit 130, a standard storage unit 140, a data classification unit 150, an output unit 160, an input unit 170, and a standard update unit 180. Note that, these blocks are functional blocks that are each functionally divided, and are not necessarily matched with actual device configurations. Specifically, in FIG. 1, a unit indicated by one block is not necessarily required to be configured by one device. Also, in FIG. 1, units indicated by separate blocks are not necessarily required to be configured by separate devices.

The operation data acquisition unit 110 is configured to acquire operation data indicative of performance relating to operations of production. The operation data acquisition unit 110 may be configured to acquire, as the operation data, data indicative of performance relating to production factors in the production management target 10, for example. As used herein, the production factor is a factor for producing a product. Among the production factors, “Material”, “Machine”, “Man” and “Method” are ‘four factors of production’ and referred to as “4M”. The operation data acquisition unit 110 may be configured to acquire, in chronological order, operation data indicative of performance relating to “4M” in the production management target 10, for example.

Here, an item relating to “Method” among “4M” is defined as an operating parameter. Specifically, the operating parameter can be defined as a parameter that can be controlled during operating. Note that, items relating to “Material”, “Machine” and “Man” among “4M” are defined as parts of operating conditions. The operating conditions may include a variety of conditions that can affect the operating in the production management target 10, such as seasons, weathers, temperatures, time zones and the like, in addition to “Material”, “Machine” and “Man”. Specifically, the operating condition can be defined as a parameter that cannot be controlled during operating.

The operation data acquisition unit 110 may be, for example, a communication unit, and is configured to acquire the operation data from the production management target 10 in chronological order via a communication network. The communication network may be a network configured to connect a plurality of computers. For example, the communication network may be a global network configured to interconnect a plurality of computers, and for example, may be the Internet using Internet protocols, and the like. Instead of this, the communication network may also be implemented by a dedicated line. Note that, in the above descriptions, the case where the operation data acquisition unit 110 acquires the operation data from the production management target 10 in chronological order via the communication network has been exemplified. However, the present invention is not limited thereto. The operation data acquisition unit 110 may also be configured to acquire the operation data from the production management target 10 via another means different from the communication network, such as a user input, a variety of memory devices and the like. The operation data acquisition unit 110 is configured to supply the acquired operation data to the data recording unit 130.

The evaluation data acquisition unit 120 is configured to acquire evaluation data indicative of performance relating to an evaluation of production. Here, the evaluation of production is an evaluation on target production. In many manufacturing industries, it is one of important issues to stably realize target PQCDS (Productivity, Quality, Cost, Delivery, Safety). Therefore, the evaluation data acquisition unit 120 may also be configured to acquire, as the evaluation data, data obtained by evaluating at least one of performances of PQCDS of the production management target 10. Before describing this, a case where the evaluation data acquisition unit 120 acquires, as the evaluation data, data (for example, a measured value obtained by actually measuring a product quality) obtained by evaluating a quality of a product produced in the production management target 10 for each lot is described as an example. As such, the evaluation data may include data obtained by evaluating the quality of the produced product. However, the present invention is not limited thereto. As described above, the evaluation data acquisition unit 120 may also be configured to acquire, as the evaluation data, data obtained by evaluating at least one of productivity, cost, delivery or safety of production in the production management target 10, instead of or in addition to the product quality. In this way, the evaluation data may include data obtained by evaluating at least one of productivity, cost, delivery or safety of production.

The evaluation data acquisition unit 120 may be a communication unit, similar to the operation data acquisition unit 110, and is configured to acquire the evaluation data obtained by evaluating the product quality from the production management target 10 via the communication network, for each lot of the product. Note that, similar to the operation data acquisition unit 110, the evaluation data acquisition unit 120 may also be configured to acquire the evaluation data from the production management target 10 via another means different from the communication network, such as a user input, a variety of memory devices and the like. The evaluation data acquisition unit 120 is configured to supply the acquired evaluation data to the data recording unit 130.

The data recording unit 130 is configured to record performance data indicative of performance of production in the production management target 10. The data recording unit 130 is configured to acquire the operation data supplied from the operation data acquisition unit 110, for example. The data recording unit 130 is also configured to acquire the evaluation data supplied from the evaluation data acquisition unit 120. The data recording unit 130 is configured to record the acquired operation data and evaluation data in association with each lot of the product, as performance data.

The standard storage unit 140 is configured to store each management standard to be complied with for a target management parameter. The standard storage unit 140 is also configured to store an evaluation standard (for example, a favorable quality standard range for determining a quality as being favorable when a measured value of the product quality is within the corresponding range) for determining an evaluation index based on the evaluation data for each target evaluation item. Here, the management standard is a standard where, for example, in order to favorably maintain a quality characteristic of a product in the production management target 10, an important parameter, which can affect the quality characteristic, is selected as a management parameter and a range of values to be taken by the parameter is defined. A relationship between the management standard and the quality characteristic of each management parameter is also referred to as QM matrix. Specifically, the standard storage unit 140 may also be configured to store each management standard to be complied with for the management parameter, which is selected as an important parameter that may affect the quality characteristic, among a plurality of items included in the operation data. Note that, the management parameter may also be selected from the operating condition and the operating parameter.

The conventional production has been operated under experienced persons by procuring materials with stable characteristics and using machines with stable performance. Under these circumstances, the operating is performed to comply with the management standard in principle, in the production management target 10. However, in recent years, due to changes in operating conditions (globalization of raw materials, aging of machines, mobilization of persons, and the like), it is difficult to favorably keep the quality characteristics of products even when the operating is performed in compliance with the management standards. In addition, due to higher quality requirements from customers, it is necessary to prevent not only large (fatal) level abnormalities but also small level abnormalities (for example, variation in quality). Under these circumstances, in the production management target 10, the operating may be performed while intentionally deviating from the management standards by wisdom of the field site, in response to changes in operating conditions. The data processing system 100 according to the present embodiment is configured to classify and output the performance data, based on a result obtained by determining whether an operation in the production management target 10 complies with the management standards, and an evaluation of production (for example, evaluation of a product quality) in the production management target 10, thereby supporting improvement on production in the production management target 10.

The data classification unit 150 is configured to access the standard storage unit 140 for referring to the evaluation standard for each to the target evaluation items. The data classification unit 150 is configured to access the data recording unit 130 and to determine each evaluation index by comparing the evaluation data recorded for each of the target evaluation items with the evaluation standard. The data recording unit 130 is configured to write the determined evaluation indexes onto the data recording unit 130.

In addition, the data classification unit 150 is configured to access the standard storage unit 140 for referring to the management standard to be complied with for each of the target management parameters. The data classification unit 150 is configured to access the data recording unit 130 and to determine whether the operation data complies with the management standard by comparing the operation data recorded for each of the target management parameters with the management standard.

The data classification unit 150 is configured to classify the performance data recorded in the data recording unit 130, based on a determination result obtained by determining whether the operation data complies with the management standards and the evaluation indexes. In this way, the data classification unit 150 is configured to classify performance data indicative of performance of production, based on the determination result obtained by determining whether the operation data complies with the management standards for the management parameter and the evaluation data. Specifically, the data classification unit 150 is configured to classify the performance data, based on two standpoints of a standpoint as to whether the operation is performed in compliance with the management standards and a standpoint of evaluation performance. This will be described later in detail. The data classification unit 150 is configured to supply the classified classification result to the output unit 160.

The output unit 160 is configured to output the classification result. The output unit 160 may be configured to display the classification result supplied from the data classification unit 150, for example. As used herein, ‘display’ is not limited to display on a monitor, and may include configuring and transmitting a screen that is to be displayed on another device or function unit. Note that, in the above descriptions, the case where the output unit 160 is configured to display the classification result has been exemplified. However, the present invention is not limited thereto. When outputting the classification result, the output unit 160 may be configured to output the classification result in various forms, such as transmission of the classification result as data to another device or function unit configured to print the classification result, voice output of the classification result, and the like.

The input unit 170 is configured to receive a user input. The input unit 170 may be configured to receive an input from a user who reviews the classification result displayed by the output unit 160. As an example, the input unit 170 may be an interface for receiving and transmitting information between a computer and a user, and particularly, may be a GUI (Graphical User Interface) using computer graphics and a pointing device. The input unit 170 is configured to supply a command corresponding to the received user input to the output unit 160 and the standard update unit 180. The output unit 160 may also be configured to change an output form of the classification result, in response to the command from the input unit 170. Thereby, the output unit 160 can output the classification result in a user's desired form.

The standard update unit 180 is configured to update at least one of the evaluation standard for determining the evaluation index based on the evaluation data, or the management standard. The standard update unit 180 may be configured to update at least one of the evaluation standard or the management standard, based on the user input, for example. Specifically, the standard update unit 180 is configured to update at least one of the evaluation standard or the management standard stored in the standard storage unit 140, in response to the command corresponding to the user input received by the input unit 170. Note that, as used herein, ‘update’ is not limited to actually updating the standard, and may include trying to change the standard.

The data classification unit 150 is configured to reclassify the performance data by using the standard after update, in response to the update of at least one of the evaluation standard or the management standard. Thereby, the output unit 160 is configured to output the reclassified classification result.

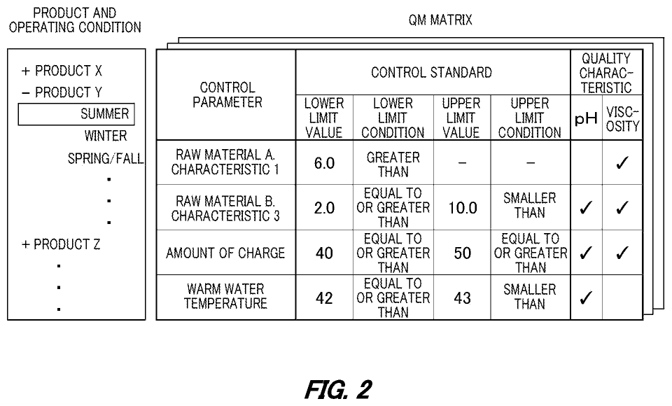

FIG. 2 shows an example of the QM matrix that is stored by the data processing system 100 according to the present embodiment. For example, the standard storage unit 140 may store the QM matrix as shown in FIG. 2, which shows a relationship between the management standard and the quality characteristic for each management parameter.

The standard storage unit 140 may store the QM matrix for each product to be produced (for example, for each of ‘product X’, ‘product Y’ and ‘product Z’). Specifically, the management parameters may be selected for each product to be produced, and the management standard may be defined for each of the management parameters. In order to define the optimal management standards according to the change in operating conditions, the standard storage unit 140 may store the QM matrix for each of the operating conditions (for example, each of ‘Summer’, ‘Winter’, ‘Spring and Fall’) as well as for each product. Specifically, the management parameters may be selected for each of the operating conditions, and the management standard may be defined for each of the management parameters. Therefore, when classifying the performance data, the data classification unit 150 may be configured to select and refer to a QM matrix suitable for a target product and operating condition from a plurality of QM matrices stored in the standard storage unit 140. Note that, FIG. 2 shows an example of the QM matrix when ‘Y’ is selected as the product and ‘Summer’ is selected as the operating condition.

FIG. 2 shows a case where ‘Raw material B. Characteristic 3’, ‘Amount of charge’ and ‘Warm water temperature’ are selected as the management parameters for managing the important parameters that can affect ‘pH’ of the quality characteristics. Similarly, FIG. 2 shows a case where ‘Raw material A. Characteristic 1’, ‘Raw material B. Characteristic 3’, and ‘Amount of charge’ are selected as the management parameters for managing the important parameters that can affect ‘viscosity’ of the quality characteristics. In this way, in the QM matrix, the different management parameters may be selected for each item of the quality characteristics.

For example, for the management parameter ‘Raw material A. Characteristic 1’, ‘Lower limit value: 6.0’ and ‘Lower limit condition: greater than’ are each defined as the management standard. Specifically, in a case of producing a product Y in Summer, it is defined as the important parameter that ‘Raw material A. Characteristic 1’ is greater than 6.0, so as to favorably keep the viscosity quality of the product Y. Similarly, for the management parameter ‘Warm water temperature’, ‘Lower limit value: 42’, ‘Lower limit condition: equal to or higher than’, ‘Upper limit value: 43’ and ‘Upper limit condition: lower than’ are each defined as the management standard. Specifically, in a case of producing a product Yin Summer, it is defined as the important parameter that the Warm water temperature is set to 42° C. or higher and lower than 43° C., so as to favorably keep the pH quality of the product Y. In this way, in order to favorably keep the evaluation characteristics (for example, the quality characteristics) of production in the production management target 10, the standard storage unit 140 stores a range of values to be taken by each of the parameters that are the important parameters, which can affect the evaluation characteristics, as the management parameters.

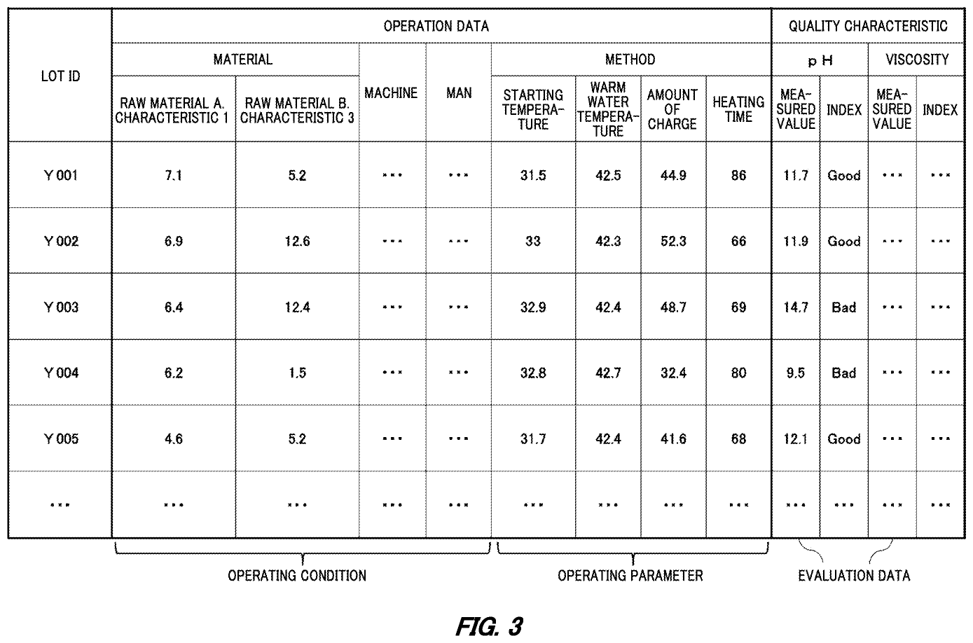

FIG. 3 shows an example of performance data that is recorded by the data processing system 100 according to the present embodiment. For example, as shown in FIG. 3, the data recording unit 130 may record, as performance data, the operation data supplied from the operation data acquisition unit 110 and the evaluation data supplied from the evaluation data acquisition unit 120, in association with a lot ID of the product. Also, the data recording unit 130 may record the evaluation index, which is determined by the data classification unit 150 comparing the evaluation data with the evaluation standard, respectively in association with the evaluation data. FIG. 3 shows an example of the performance data associated with lot #001 to lot #005 of the product Y.

As shown in FIG. 3, the data recording unit 130 may record, as the operation data, data indicative of performance relating to each of “4M”, i.e., “Material”, “Machine”, “Man” and “Method” in the production management target 10. Note that, as described above, items relating to “Material”, “Machine” and “Man” of “4M” are defined as parts of the operating conditions. Also, an item relating to “Method” of “4M” is defined as the operating parameter.

In FIG. 3, data ‘Raw material A. Characteristic 1’, which indicates an inspection result as to a property of Characteristic 1 for raw material A, and data ‘Raw material B. Characteristic 3’, which indicates an inspection result as to a property of characteristic 3 for raw material B, are shown as an example of data indicative of performance relating to “Material”. Note that, in FIG. 3, data indicating performance relating to “Machine” and “Man” is omitted. Similarly, in FIG. 3, ‘Starting temperature’, ‘Warm water temperature’, ‘Amount of charge’ and ‘Heating time’ are shown as an example of data indicative of performance relating to “Method”.

In addition, the data recording unit 130 may also be configured to record, as the evaluation data, data obtained by evaluating performance of PQCDS in the production management target 10. For example, as shown in FIG. 3, the data recording unit 130 may record, as the evaluation data, data obtained by evaluating qualities of pH and viscosity of the product Y. In FIG. 3, as the evaluation data of pH of the product Y, a measured value obtained by actually measuring pH of the product Y is shown as an example. Also, in FIG. 3, as the evaluation index obtained by evaluating pH of the product Y, an index indicating whether a measured value of pH meets (Good) a predetermined evaluation standard or not (Bad) is shown as an example. Note that, in FIG. 3, the evaluation data obtained by evaluating the viscosity of the product Y is omitted. Here, in the above descriptions, the case where the evaluation index is the index classified into two values (Good/Bad) depending on whether the measured value meets (Good) the predetermined evaluation standard or not (Bad) has been exemplified. However, the present invention is not limited thereto. The evaluation index may also be an index (for example, ranks, grades and the like) classified into multiple values by comparing the measured value with the predetermined evaluation standard.

The data recording unit 130 is configured to record the performance data acquired for the plurality of lots in this way, as a target of data processing. The data processing system 100 according to the present embodiment is configured to classify the performance data and to output a classification result. At this time, the data processing system 100 according to the present embodiment is configured to classify the performance data, based on a result obtained by determining whether an operation in the production management target 10 complies with the management standards, and an evaluation of production in the production management target 10. This is described in detail with reference to a flow.

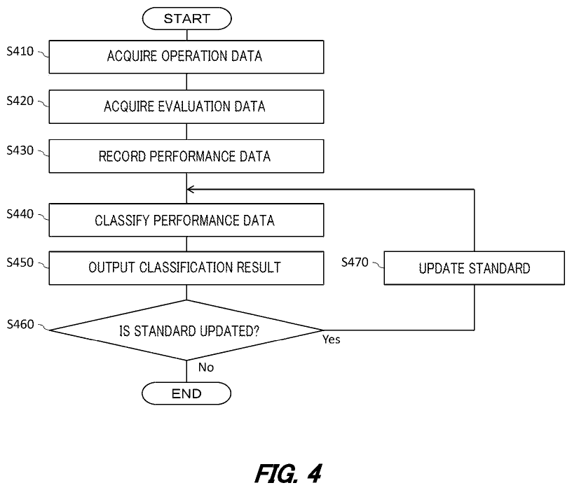

FIG. 4 shows an example of a flow by which the data processing system 100 according to the present embodiment processes data.

In step 410, the data processing system 100 acquires the operation data. For example, the operation data acquisition unit 110 acquires, in chronological order, the operation data indicative of the performance relating to the operation of production from the production management target 10, via the communication network. As an example, the operation data acquisition unit 110 may acquire, in chronological order, the operation data indicative of the performance relating to “4M”, i.e., “Material”, “Machine”, “Man” and “Method” in the production management target 10.

The operation data acquisition unit 110 may also acquire, as the operation data relating to “Material”, inspection data obtained by inspecting materials in the production management target 10. The operation data acquisition unit 110 may also acquire, as the operation data relating to “Machine”, data indicative of a degree of soundness of machine in the production management target 10. The operation data acquisition unit 110 may also acquire, as the operation data relating to “Man”, data indicative of a schedule of an operator in the production management target 10. The operation data acquisition unit 110 may also acquire, as the operation data relating to “Method”, measurement data from sensors provided in the production management target 10 and control data on actuators. The operation data acquisition unit 110 supplies the acquired operation data to the data recording unit 130.

In step 420, the data processing system 100 acquires the evaluation data. For example, the evaluation data acquisition unit 120 acquires the evaluation data indicative of performance relating to an evaluation of production, for each lot of the product, via the communication network. As an example, the evaluation data acquisition unit 120 may acquire data obtained by evaluating at least one of performances of PQCDS in the production management target 10. Here, it is assumed that the evaluation data acquisition unit 120 acquires the evaluation data obtained by evaluating the quality of a product that is produced in the production management target 10, for each lot of the product. Specifically, the evaluation data may include data obtained by evaluating the quality of the produced product. However, the present invention is not limited thereto. As described above, the evaluation data may include data obtained by evaluating at least one of productivity, cost, delivery or safety of production. The evaluation data acquisition unit 120 supplies the acquired evaluation data to the data recording unit 130.

In step 430, the data processing system 100 records the performance data. For example, the data recording unit 130 associates the operation data acquired in step 410 and the evaluation data acquired in step 420 for each lot of the product, and records the same, as the performance data.

As an example, the data recording unit 130 associates the operation data acquired in step 410 so as to be data in the same time zone. The reason to perform the association is because the output timing of the acquired operation data may differ for each production factor. Then, the data recording unit 130 perceives the start point and end point of the method in the production management target 10, from the acquired operation data, and identifies the operation data for each lot. Then, the data recording unit 130 associates the operation data identified for each lot with the evaluation data acquired for each lot in step 420, and records the same, as the performance data. Also, the data recording unit 130 records the evaluation index, which is determined by the data classification unit 150 comparing the evaluation data with the evaluation standard, respectively in association with the evaluation data.

In step 440, the data processing system 100 classifies the performance data. For example, the data classification unit 150 accesses the standard storage unit 140, and selects and refers to a QM matrix suitable for a target product and operating condition from the plurality of QM matrices stored in the standard storage unit 140. Also, the data classification unit 150 accesses the data recording unit 130, and refers to the performance data recorded in step 430. Then, the data classification unit 150 classifies the performance data indicative of the performance of production, based on the determination result obtained by determining whether the operation data complies with the management standards for the management parameters, and the evaluation data. This is to be described in detail.

The data classification unit 150 accesses the standard storage unit 140 and refers to the QM matrices shown in FIG. 2, for example. Thereby, the data classification unit 150 recognizes that ‘Raw material B. Characteristic 3’, ‘Amount of charge’ and ‘Warm water temperature’ are selected as the management parameters for managing the important parameters that can affect ‘pH’ of the quality characteristics. Also, the data classification unit 150 recognizes the range of values to be taken by each of the management parameters of ‘Raw material B. Characteristic 3’, ‘Amount of charge’ and ‘Warm water temperature’.

Also, the data classification unit 150 accesses the data recording unit 130, and refers to the performance data shown in FIG. 3. Then, the data classification unit 150 analyzes the performance data shown in FIG. 3 by using the QM matrix shown in FIG. 2, for example.

As an example, seeing the performance data associated with lot ID ‘Y001’, the operation data of ‘Raw material B. Characteristic 3’ relating to the operating condition among the management parameters complies with the management standard. Also, the operation data of ‘Amount of charge’ and ‘Warm water temperature’ relating to the operating condition of the management parameter all complies with the management standards. In addition, ‘pH’ is evaluated as ‘Good’ meeting the predetermined standard. The performance data can be acquired, for example, in a case where, in the production management target 10, the raw material B complying with the management standard is purveyed and the operating is performed in compliance with the management standard, so that pH of the product is made favorable. In this way, the performance data associated with lot ID ‘Y001’ indicates a case where the good quality is obtained as the operating is performed while complying with the management standards. The data classification unit 150 categorizes the performance data, in which the operation data complies with the management standards for all items relating to the operating parameters among the management parameters and the evaluation data meets the predetermined standard, into ‘Classification 1’. In ‘Classification 1’, it is an issue to aim for a higher quality target (for example, reduction in variation).

Similarly, when seeing the performance data associated with lot ID ‘Y002’, the operation data of ‘Raw material B. Characteristic 3’ deviates from the management standard. Also, the operation data of ‘Warm water temperature’ complies with the management standard, and the operation data of ‘Amount of charge’ deviates from the management standard. In addition, pH is evaluated as ‘Good’. The performance data can be acquired, for example, in a case where, in the production management target 10, the raw material B deviating from the management standard is purveyed but the operating is performed while adjusting ‘Amount of charge’ to deviate from the management standard (for example, ‘Amount of charge’ is made larger than 50 that is the upper limit of the management standard) by wisdom of the field site, so that pH of the product is made favorable. In this way, the performance data associated with lot ID ‘Y002’ indicates a case where the good quality is obtained as the operating is performed while not complying with the management standard. The data classification unit 150 categorizes the performance data, in which the operation data deviates from the management standard for at least one item relating to the operating parameters among the management parameters and the evaluation data meets the predetermined standard, into ‘Classification 2’. In ‘Classification 2’, it is an issue to standardize the experience that the quality is made favorable by the wisdom of the field site.

Similarly, when seeing the performance data associated with lot ID ‘Y003’, the operation data of ‘Raw material B. Characteristic 3’ deviates from the management standard. Also, the operation data of ‘Warm water temperature’ and ‘ Amount of charge’ all complies with the management standards. In addition, ‘pH’ is evaluated as ‘Bad’ not meeting the predetermined standard. The performance data can be acquired, for example, in a case where, in the production management target 10, the raw material B deviating from the management standard is purveyed but the operating is performed in compliance with the management standard without taking any measures in the field site, so that pH of the product becomes poor. In this way, the performance data associated with lot ID ‘Y003’ indicates a case where the bad quality is obtained as the operating is performed in compliance with the management standard. The data classification unit 150 categorizes the performance data, in which the operation data complies with the management standards for all items relating to the operating parameters among the management parameters and the evaluation data does not meet the predetermined standard, into ‘Classification 3’. In ‘Classification 3’, it is an issue to adjust the operating parameters according to the changes in operating conditions.

Similarly, when seeing the performance data associated with lot ID ‘Y004’, the operation data of ‘Raw material B. Characteristic 3’ deviates from the management standard. Also, the operation data of ‘Warm water temperature’ complies with the management standard, and the operation data of ‘Amount of charge’ deviates from the management standard. In addition, pH is evaluated as Bad. The performance data can be acquired, for example, in a case where, in the production management target 10, since the raw material B deviating from the management standard is purveyed, the operating is performed while ‘Amount of charge’ is adjusted to deviate from the management standard by the wisdom of the side in the field site but pH of the product becomes poor. Specifically, the performance data associated with lot ID ‘Y004’ indicates a case where the bad quality is obtained as the operating is performed while not complying with the management standard. The data classification unit 150 categorizes the performance data, in which the operation data deviates from the management standard for at least one item relating to the operating parameters among the management parameters and the evaluation data does not meet the predetermined standard, into ‘Classification 4’. In ‘Classification 4’, it is an issue to aim for correct recovery when the operating condition has changed.

In this way, the data classification unit 150 classifies the performance data into the at least four, depending on whether the operation data complies with the management standards for all items relating to the operating parameters among the management parameters, and whether the evaluation data meets the predetermined standard. In this way, the data classification unit 150 may be configured to classify the performance data from the overall viewpoint of the operation in the production management target 10.

In addition to this, the data classification unit 150 may also be configured to classify the performance data from each viewpoint of each management parameter. For example, the data classification unit 150 pays attention to ‘Raw material B. Characteristic 3’, and classifies the operation data of ‘Raw material B. Characteristic 3’ into three cases, according to the management standards defined in the QM matrix. As an example, the data classification unit 150 categorizes the performance data, in which the operation data of ‘Raw material B. Characteristic 3’ is equal to or larger than 2.0 and smaller than 10.0, into ‘Classification C’ indicating that the operation data of the target management parameter complies with the management standard.

Similarly, the data classification unit 150 categorizes the performance data, in which the operation data of ‘Raw material B. Characteristic 3’ is equal to or larger than 10.0, into ‘Classification U’ indicating that the operation data of the target management parameter deviates upward from the management standard.

Similarly, the data classification unit 150 categorizes the performance data, in which the operation data of ‘Raw material B. Characteristic 3’ is smaller than 2.0, into ‘Classification L’ indicating that the operation data of the target management parameter deviates downward from the management standard.

Then, the data classification unit 150 determines whether the evaluation data meets the predetermined standard for each of ‘Classification C’, ‘Classification U’ and ‘Classification L’, and classifies the performance data into two. Specifically, for example, the data classification unit 150 classifies the performance data categorized into ‘Classification C’ into two of a case where ‘pH’ is evaluated as ‘Good’ and a case where ‘pH’ is evaluated as ‘Bad’. Similarly, the data classification unit 150 classifies the performance data categorized into ‘Classification U’ and ‘Classification L’ into two. The data classification unit 150 executes the classification for each of all items selected as the management parameters in the QM matrix. In this way, the data classification unit 150 classifies the performance data, depending on whether the evaluation data meets the predetermined standard, for each of the case where the operation data complies with the management standard, the case where the operation data deviates upward from the management standard and the case where the operation data deviates downward from the management standard, for each item of the management parameter. Thereby, for example, the data classification unit 150 can classify whether pH is good or bad for each of the cases where ‘Raw material B. Characteristic 3’ complies with the management standard, and deviates upward and downward from the management standard.

In step 450, the data processing system 100 outputs the classification result. For example, the output unit 160 displays the classification result classified in step 440 on a monitor. As an example, the output unit 160 may output the classification result in which the data classification unit 150 classifies the performance data from the overall viewpoint of the operation in the production management target 10 in step 440. At this time, the output unit 160 may be configured to output a display screen for displaying each frequency classified into the at least four, as a graph.

In addition to this, the output unit 160 may be configured to output the classification result in which the data classification unit 150 classifies the performance data from each viewpoint of each management parameter in step 440. At this time, the output unit 160 may be configured to output a display screen for displaying a frequency as to whether the evaluation data meets the predetermined standard for each case, for each item of the management parameter, as a graph. The display screen that is output by the output unit 160 will be described later in detail.

Note that, the output unit 160 may also be configured to switch the classification result, which is output in response to the command from the input unit 170, between the classification result where the performance data is classified from the overall viewpoint of the operating in the production management target 10 and the classification result where the performance data is classified from each view point of each management parameter.

In step 460, the data processing system 100 determines whether to update the standard. For example, the standard update unit 180 may determine whether to update the standard, depending on whether a command to update the standard is supplied from the input unit 170. When it is determined in step 460 that the standard is not to be updated, the data processing system 100 ends the flow.

On the other hand, when it is determined in step 460 that the standard is to be updated, the data processing system 100 updates the standard, in step 470. For example, the standard update unit 180 is configured to update at least one of the evaluation standard for determining the evaluation index based on the evaluation data or the management standard, in response to the command corresponding to the user input received by the input unit 170. In this way, the standard update unit 180 may be configured to update at least one of the evaluation standard or the management standard, based on the user input, for example.

When the standard is updated in step 470, the data processing system 100 returns the processing to step 440 and continues the flow. Specifically, in step 440 subsequent to step 470, the data classification unit 150 reclassifies the performance data by using the standard after update, in response to the update of at least one of the evaluation standard or the management standard. Then, in step 450 subsequent to step 470, the output unit 160 outputs the reclassified classification result.

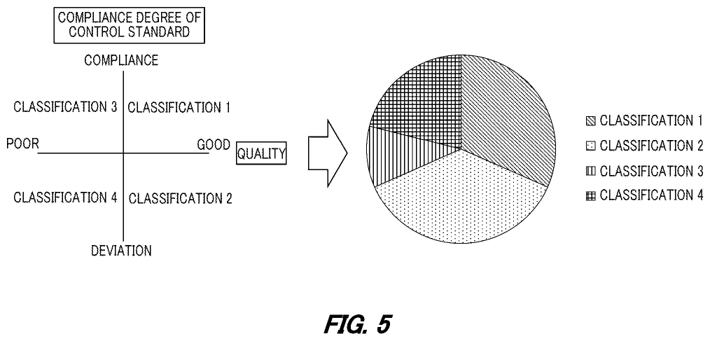

FIG. 5 shows an example of the classification result that is output by the data processing system 100 according to the present embodiment. FIG. 5 shows an output example of the classification result in which the performance data is classified from the overall viewpoint of the operating in the production management target 10. The data processing unit 100 is configured to classify the performance data, based on two standpoints of a standpoint as to whether the operation is performed in compliance with the management standards and a standpoint of evaluation performance. As described above, as an example, the data classification unit 150 categorizes the performance data, in which the operation data complies with the management standards for all items relating to the operating parameters among the management parameters and the evaluation data meets the predetermined standard, into ‘Classification 1’. Also, the data classification unit 150 categorizes the performance data, in which the operation data deviates from the management standard for at least one item relating to the operating parameters among the management parameters and the evaluation data meets the predetermined standard, into ‘Classification 2’. In addition, the data classification unit 150 categorizes the performance data, in which the operation data complies with the management standards for all items relating to the operating parameters among the management parameters and the evaluation data does not meet the predetermined standard, into ‘Classification 3’. Further, the data classification unit 150 categorizes the performance data, in which the operation data deviates from the management standard for at least one item relating to the operating parameters among the management parameters and the evaluation data does not meet the predetermined standard, into ‘Classification 4’. On the left of FIG. 5, the state where the performance data is categorized into four from the two standpoints is schematically shown.

The data processing system 100 of the present embodiment may also be configured to aggregate the classification results classified in this way, and to display the aggregated classification result as a graph, as shown on the right in FIG. 5. Specifically, the output unit 160 may output a display screen for displaying each frequency classified into at least four as a graph. In FIG. 5, a case where the output unit 160 displays a pie chart where each frequency is expressed by a ratio is shown as an example. However, the present invention is not limited thereto. The output unit 160 may display a graph of any form capable of expressing each frequency, such as a bar graph, a band graph, a histogram, a radar chart and the like, instead of the pie chart.

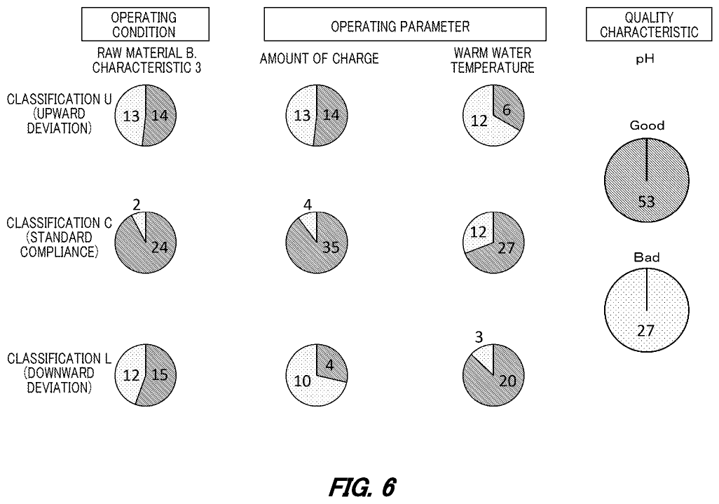

FIG. 6 shows an example of another classification result that is output by the data processing system 100 according to the present embodiment. FIG. 6 shows an output example of the classification result in which the performance data is classified from each viewpoint of each management parameter. In FIG. 6, a case where the performance data of 80 lots are classified from each viewpoint of each management parameter is shown as an example. In FIG. 6, a case where ‘pH’ is evaluated as ‘Good’, i.e., favorable in 53 lots of 80 lots and is evaluated as ‘Bad’, i.e., poor in 27 lots. The data processing system 100 of the present embodiment classifies the performance data into each of cases where the operation data complies with the management standards, and deviates upward and downward from the management standards for each item of the management parameters, for enabling more detailed analysis. As described above, as an example, the data classification unit 150 categorizes the performance data where the operation data of ‘Raw material B. Characteristic 3’ is equal to or greater than 2.0 and smaller than 10.0 into ‘Classification C’, the performance data where the operation data is equal to or greater than 10.0 into ‘Classification U’ and the performance data where the operation data is smaller than 2.0 into ‘Classification L’, respectively. The data classification unit 150 classifies each of ‘Classification C’, ‘Classification U’ and ‘Classification L’ into two of a case where ‘pH’ is evaluated as ‘Good’ and a case where ‘pH’ is evaluated as ‘Bad’. The data classification unit 150 executes the classification for each of all items selected as the management parameters in the QM matrix.

FIG. 6 shows, for example, that the operation data of ‘Raw material B. Characteristic 3’ deviates upward from the management standard in 27 lots of 80 lots, and pH is finally evaluated as favorable in 14 lots thereof and is evaluated as poor in the other 13 lots. Similarly, FIG. 6 shows, for example, that the operation data of ‘Raw material B. Characteristic 3’ complies with the management standard in 26 lots of 80 lots, and pH is finally evaluated as favorable in 24 lots thereof and is evaluated as poor in the other 2 lots. Similarly, FIG. 6 shows, for example, that the operation data of ‘Raw material B. Characteristic 3’ deviates downward from the management standard in 27 lots of 80 lots, and pH is finally evaluated as favorable in 15 lots thereof and is evaluated as poor in the other 12 lots. The other management parameters are also similar. As shown in FIG. 6, the output unit 160 may output a display screen for displaying a frequency as to whether the evaluation data meets the predetermined standard for each case, for each item of the management parameters, as a graph. Note that, in FIG. 6, the output unit 160 displays the pie chart, as an example, but may also display a graph of any form. The output unit 160 may also be configured to display each graph by arranging a display order of each management parameter from left to right according to a time order recognized by an operator so as to follow the time order. Thereby, it becomes easier to understand a propagation aspect of an event that has occurred. The output unit 160 may also be configured not to display parts of the management parameters to be displayed. Thereby, even when the number of the management parameters increases, it is possible to check only the important management parameters and the like that affect the quality.

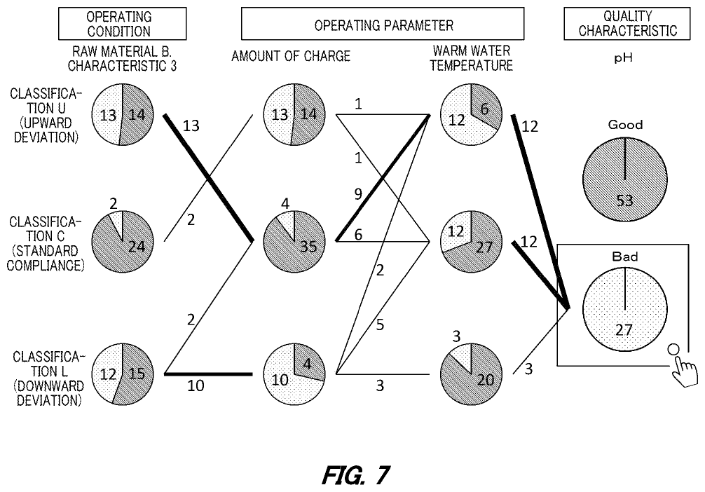

FIG. 7 shows an example of another classification result that is output so as to support a finding of a deviation pattern by the data processing system 100 according to the present embodiment. Here, when the operation data is determined by comparing the same with the management standard, for each item of the management parameters, a point whereby the operation data deviates from the management standard, i.e., a point that is estimated as a cause due to which the evaluation data does not meet the predetermined standard is defined as “deviation point”. Also, a combination of each case relating to the plurality of items of the management parameters, which includes at least one “deviation point”, is defined as “deviation pattern”.

For example, it is assumed that the user selects and clicks a graph (a graph on the right lower side) showing a case where ‘pH’ is finally evaluated as ‘Bad’ via the input unit 170, in the display of the classification result shown in FIG. 6. In this case, the output unit 160 may output the display screen as shown in FIG. 6. Specifically, the output unit 160 may display a pass in which ‘pH’ is finally evaluated as ‘Bad’, and the number of lots thereof. Here, the output unit 160 may display the pass with a thickness corresponding to the number of lots, for example. Specifically, the output unit 160 may display the pass in which the number of lots is large thicker than the pass in which the number of lots is small. In this way, the output unit 160 may output a display screen for showing an association as to which of the cases data, in which the evaluation data does not meet the predetermined standard, of the performance data corresponds to, for each item of the management parameters.

As shown in FIG. 6, it can be seen that ‘Raw material B. Characteristic 3’ deviates upward in 13 lots, which is about a half of 27 lots in which ‘pH’ is finally evaluated as ‘Bad’. Therefore, it can be considered that the upward deviation in ‘Raw material B. Characteristic 3’ is one of the deviation points. FIG. 6 also shows, for example, that the number of lots is 13 for the pass from ‘Classification U’ in ‘Raw material B. Characteristic 3’ to ‘Classification C’ in ‘Amount of charge’. This indicates that 13 lots of 27 lots in which ‘pH’ is finally evaluated as ‘Bad’ has been operated so that the operation data of ‘Raw material B. Characteristic 3’ deviates upward and ‘Amount of charge’ complies with the management standard. Therefore, it can be considered that a combination of the upward deviation as to ‘Raw material B. Characteristic 3’ and the standard compliance as to ‘Amount of charge’ is one of the deviation patterns. In this way, the user can find the deviation pattern by reviewing the classification result output by the data processing system 100 according to the present embodiment.

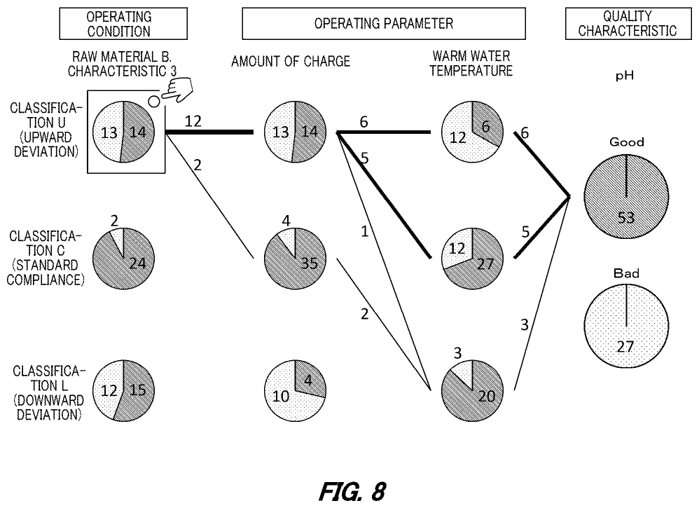

FIG. 8 shows an example of another classification result that is output so as to support a finding of a recovery method by the data processing system 100 according to the present embodiment. Here, the recovery method is a method for recovering the deviation pattern. For example, it is assumed that the user who reviews the classification result shown in FIG. 7 found out that the deviation pattern estimated as the cause due to which ‘pH’ is finally evaluated as ‘Bad’ is a combination of the upward deviation as to ‘Raw material B. Characteristic 3’ and the standard compliance as to ‘Amount of charge’. Also, it is assumed that the user selects and clicks a graph (a graph on the left upper side) showing the deviation point, i.e., the case where ‘Raw material B. Characteristic 3’ deviates upward via the input unit 170, in the display of the classification result shown in FIG. 7. In this case, the output unit 160 may output the display screen as shown in FIG. 7. Specifically, the output unit 160 may display a pass in which ‘pH’ is finally evaluated as ‘Good’, and the number of lots thereof, through the selected case. At this time, the output unit 160 may display the pass with a thickness corresponding to the number of lots, similar to the display screen shown in FIG. 7. In this way, the output unit 160 may output a display screen for showing an association as to which of the cases data, in which the evaluation data meets the predetermined standard, of the performance data corresponds to, for each item of the management parameters.

FIG. 8 shows, for example, that the number of lots is 12 for the pass from ‘Classification U’ in ‘Raw material B. Characteristic 3’ to ‘Classification C’ in ‘Amount of charge’. Similarly, FIG. 8 shows, for example, that the number of lots is 2 for the pass from ‘Classification U’ in ‘Raw material B. Characteristic 3’ to ‘Classification C’ in ‘Amount of charge’. This indicates that even when ‘Raw material B. Characteristic 3’ deviates upward, ‘pH’ is evaluated as favorable in 14 lots, the operation is performed while adjusting ‘Amount of charge’ to deviate upward, in 12 lots thereof, and the operation is performed while ‘Amount of charge’ complies with the management standard in the other 2 lots. Therefore, it can be considered that, when ‘Raw material B. Characteristic 3’ deviates upward, the adjustment is made so that ‘Amount of charge’ deviates upward, and therefore, the frequency to evaluate ‘pH’ as being favorable increases. Accordingly, the user can find out that adjusting ‘Amount of charge’ to deviate upward is the recovery method for the deviation pattern. In this way, the user can find out the recovery method for each deviation pattern by reviewing the classification result output by the data processing system 100 according to the present embodiment.

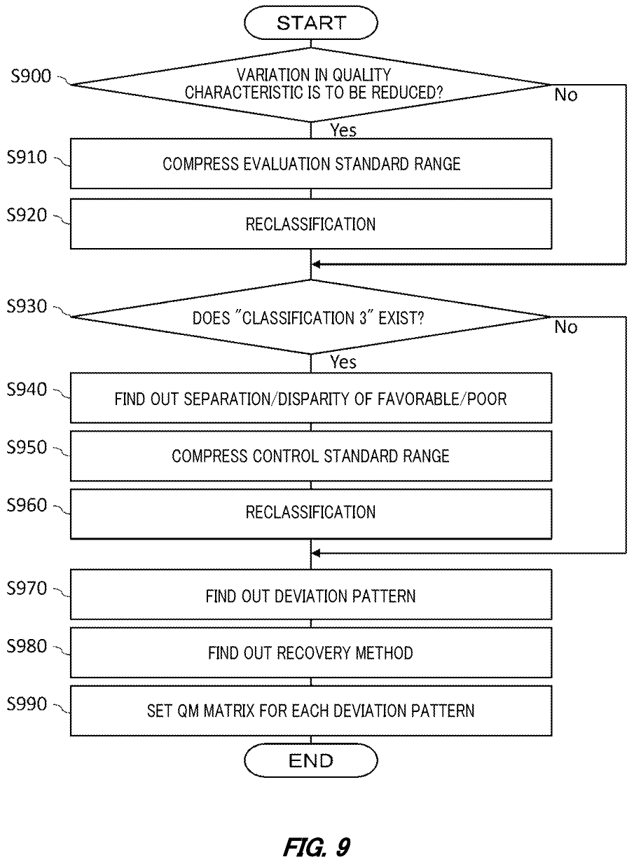

FIG. 9 shows an example of a flow of updating the evaluation standard and the management standard by using the data processing system 100 according to the present embodiment.

Steps 900 to 920 are steps for solving the problems in ‘Classification 1’. Specifically, steps 900 to 920 are executed for the purpose of further reducing variation in product quality so as to meet high quality demands from customers.

In step 900, the data processing system 100 determines whether to reduce the variation in quality characteristics. For example, the data processing system 100 may determine whether to reduce the variation in quality characteristics, depending on whether a user input of demanding to reduce the variation in quality characteristics is received via the input unit 170.

When it is determined in step 900 that the variation in quality characteristics is not to be reduced, the data processing system 100 shifts the processing to step 930. On the other hand, when it is determined in step 900 that the variation in quality characteristics is to be reduced, the data processing system 100 shifts the processing to step 910.

In step 910, the data processing system 100 compresses the evaluation standard range. For example, the data processing system 100 displays the classification result where the performance data is classified from the overall viewpoint of the operation in the production management target 10. At this time, as an example, the data processing system 100 may also display a histogram where the measured values of the evaluation item, which is to be updated, of the evaluation standard are indicated on the horizontal axis and the frequency of each measured value is indicated on the vertical axis. When the data processing system 100 receives a user input of demanding to change a favorable quality standard range via the input unit 170, for example, the data processing system 100 may compress the favorable quality standard range, i.e., the evaluation standard range, in response to a command corresponding to the input.

In step 920, the data processing system 100 reclassifies the performance data. The data processing system 100 reclassifies the performance data by using the evaluation standard updated in step 910. As a result, some of the performance data categorized into ‘Classification 1’ is newly categorized into ‘Classification 3’ under the evaluation standard after update, and some of the performance data categorized into ‘Classification 2’ is newly categorized into ‘Classification 4’ under the updated evaluation standard. This will be described later in detail. In this way, the data processing system 100 updates the evaluation standard so that the variation in product quality is further reduced.

Steps 930 to 960 are steps for solving the problems in ‘Classification 3’. Specifically, steps 930 to 960 are executed for the purpose of compressing the management standard so that, when there is the performance data categorized into ‘Classification 3’, a good product is always obtained if the operation is performed in compliance with the management standard.

In step 930, the data processing system 100 determines whether there is ‘Classification 3’. For example, the data processing system 100 may determine whether there is ‘Classification 3’, depending on whether there is the performance data categorized into ‘Classification 3’ in the classified performance data.

When it is determined in step 930 that the there is no ‘Classification 3’, the data processing system 100 shifts the processing to step 970. On the other hand, when it is determined in step 930 that there is ‘Classification 3’, the data processing system 100 shifts the processing to step 940.

In step 940, the user finds out separation and/or disparity of favorable/poor. As an example, the data processing system 100 may display a histogram or a scatter plot of performance values of the management parameters. The user who reviews the display screen finds out a parameter for which a distribution of favorable/poor in the product quality has separation or disparity.

In step 950, the data processing system 100 narrows the management standard range. For example, the data processing system 100 may display a histogram where the performance values of the management parameter found in step 940 are indicated on the horizontal axis and the frequency of each performance value is indicated on the vertical axis. When the data processing system 100 receives a user input of demanding to change the management standard range via the input unit 170, for example, the data processing system 100 may compress the management standard range, in response to a command corresponding to the input.

In step 960, the data processing system 100 reclassifies the performance data. The data processing system 100 reclassifies the performance data by using the management standard updated in step 950. As a result, some of the performance data categorized into ‘Classification 1’ is newly categorized into ‘Classification 2’ under the management standard after update, and all of the performance data categorized into ‘Classification 3’ is newly categorized into ‘Classification 4’ under the management standard after update. This will be described later in detail. In this way, the data processing system 100 updates the management standard so that the performance data categorized into ‘Classification 3’ does not exist.

The processing from step 970 to step 990 is to solve the problems in ‘Classification 4’. Specifically, steps 970 to 990 are executed for the purpose of setting a new QM matrix by finding out the deviation pattern from the performance data categorized into ‘Classification 4’ and finding out a recovery method thereof from the performance data categorized into ‘Classification 2’.

In step 970, the user finds out a deviation pattern, for example. As an example, the data processing system 100 outputs a display screen for showing the classification result (for example, FIG. 6) where the performance data is classified from each viewpoint of each management parameter. For example, it is assumed that the user selects and clicks a graph showing a case where ‘pH’ is finally evaluated as ‘Bad’ via the input unit 170, in the display of the classification result shown in FIG. 6. In response to this, the data processing system 100 outputs a display screen (for example, FIG. 7) for showing an association as to which of the cases data, in which the evaluation data does not meet the predetermined standard, of the performance data corresponds to, for each item of the management parameters. Then, the user who reviews the display screen finds out a deviation pattern.

In step 980, the user finds out a recovery method, for example. As an example, it is assumed that the user selects and clicks a graph showing the deviation point, i.e., the case where ‘Raw material B. Characteristic 3’ deviates upward via the input unit 170, in the display of the classification result shown in FIG. 7. In response to this, the data processing system 100 outputs a display screen (for example, FIG. 8) for showing an association as to which of the cases data, in which the evaluation data meets the predetermined standard, of the performance data corresponds to, for each item of the management parameters. Then, the user who reviews the display screen finds out a recovery method for each deviation pattern.

In step 990, the data processing system 100 sets the QM matrix for each deviation pattern. For example, when the data processing system 100 receives a user input of demanding to set the management standard for each deviation pattern via the input unit 170 from the user who has found out the recovery method in step 980, the data processing system 100 may newly set the QM matrix for each deviation pattern, in response to a command corresponding to the input. This will be described later in detail. In this way, the data processing system 100 ends the flow of updating the evaluation standard and the management standard.

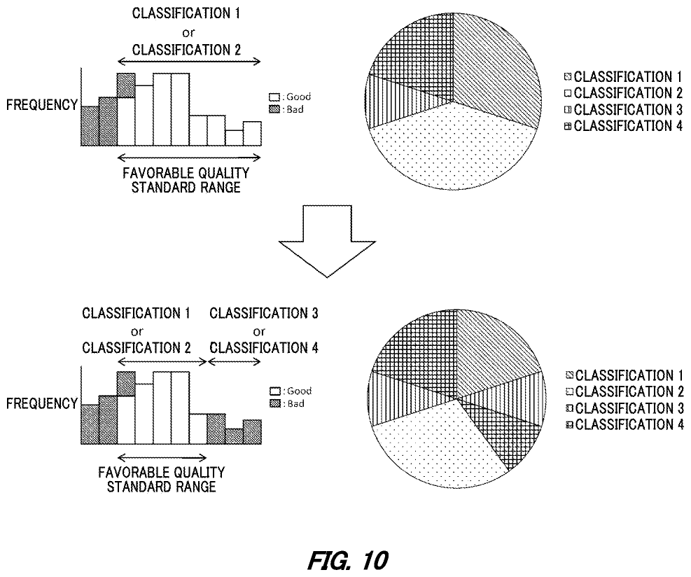

FIG. 10 schematically shows an example of a change in classification result when an evaluation standard range is compressed using the data processing system 100 according to the present embodiment. The upper of FIG. 10 shows a classification result before an evaluation standard range (favorable quality standard range) is compressed. The lower of FIG. 10 shows a classification result after the evaluation standard range is compressed. The left of FIG. 10 shows a histogram where the measured values of the evaluation item, which is to be updated, of the evaluation standard are indicated on the horizontal axis and the frequency of each measured value is indicated on the vertical axis. The right of FIG. 10 shows a pie chart showing the classification result in which the performance data is classified from the overall viewpoint of the operating in the production management target 10.

As shown in FIG. 10, the favorable quality standard range is compressed, so that some of the performance data categorized into ‘Classification 1’ is newly categorized into ‘Classification 3’ under the evaluation standard after update, and some of the performance data categorized into ‘Classification 2’ is newly categorized into ‘Classification 4’ under the evaluation standard after update. In this way, the data processing system 100 updates the evaluation standard so that the variation in product quality is further reduced.

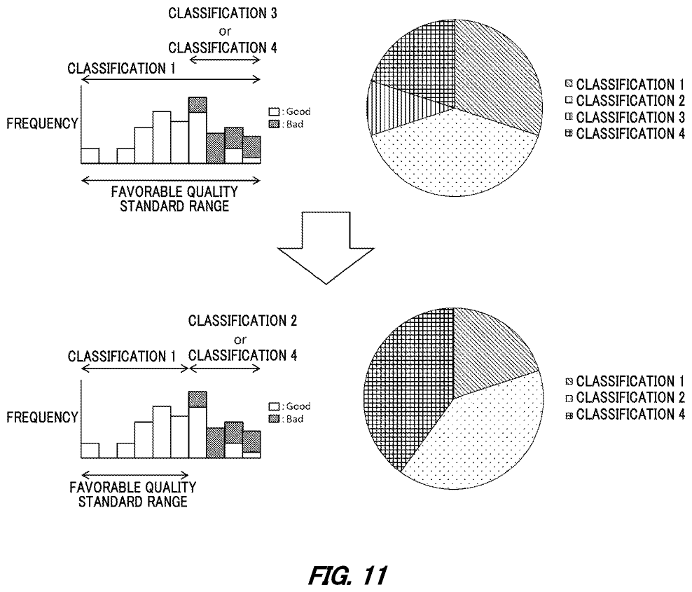

FIG. 11 schematically shows an example of a change in classification result when a management standard range is compressed using the data processing system 100 according to the present embodiment. The upper of FIG. 11 shows a classification result before the management standard range is compressed. The lower of FIG. 11 shows a classification result after the management standard range is compressed. The left of FIG. 11 shows a histogram where the performance values of the management parameter, which is to be updated, of the management standard are indicated on the horizontal axis and the frequency of each performance value is indicated on the vertical axis. The right of FIG. 11 shows a pie chart showing the classification result in which the performance data is classified from the overall viewpoint of the operating in the production management target 10.

As shown in FIG. 11, the management standard range is compressed, so that some of the performance data categorized into ‘Classification 1’ is newly categorized into ‘Classification 2’ under the management standard after update, and all of the performance data categorized into ‘Classification 3’ is newly categorized into ‘Classification 4’ under the management standard after update. In this way, the data processing system 100 updates the management standard so that the performance data categorized into ‘Classification 3’ does not exist.

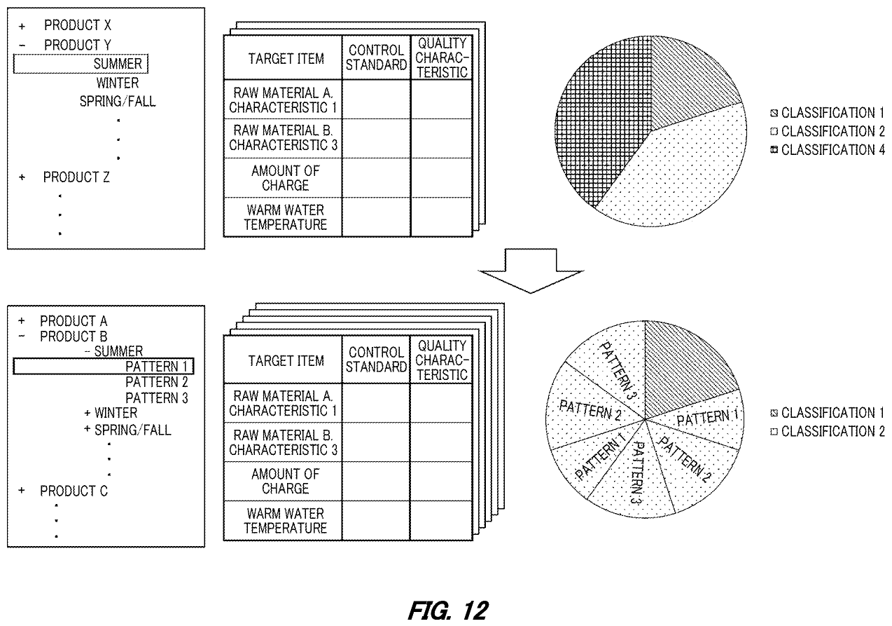

FIG. 12 schematically shows an example of the change in classification result when the QM matrix is set for each deviation pattern by using the data processing system 100 according to the present embodiment. The upper of FIG. 12 shows a classification result before the QM matrix is set for each deviation pattern. The lower of FIG. 12 shows a classification result after the QM matrix is set for each deviation pattern. The left of FIG. 12 shows the set QM matrix for each operating condition. The right of FIG. 12 shows a pie chart showing the classification result in which the performance data is classified from the overall viewpoint of the operating in the production management target 10.

The data processing system 100 of the present embodiment sets a new QM matrix for each deviation pattern by finding out the deviation pattern from the performance data categorized into ‘Classification 4’ and finding out a recovery method thereof from the performance data categorized into ‘Classification 2’. For example, in FIG. 12, ‘Pattern 1’ may indicate a case where ‘Raw material B. Characteristic 3’ deviates upward, i.e., a case where ‘Raw material B. Characteristic 3’ is ‘equal to or greater than 10’. In the QM matrix newly prepared as ‘Pattern 1’, for example, ‘Lower limit value: 50’, ‘Lower limit condition: greater than’, ‘Upper limit value: 55’ and ‘Upper limit condition: equal to or smaller than’ may be each defined as the management standard for ‘Amount of charge’, for example.

The QM matrix is set for each deviation pattern, so that all of the performance data categorized into ‘Classification 4’ is newly categorized into ‘Classification 2’ under the QM matrix for each deviation pattern. In this way, the data processing system 100 may set the QM matrix for each deviation pattern so that the performance data to be categorized into ‘Classification 4’ does not exist. Specifically, the data processing system 100 according to the present embodiment newly sets the QM matrix for each deviation pattern by using the found deviation pattern as a new operating condition. Thereby, when a condition similar to a pattern that has occurred in the past occurs, the data processing system 100 can operate according to the QM matrix prepared for each deviation pattern.

In the related art, due to the change in operating condition and the like, even when the operating is performed while complying with the management standards, the evaluation characteristic of production may not be favorably kept, in some cases. Also, in some cases, it was unclear how to change the management standards so as to favorably keep the evaluation characteristic of production. Under such situations, the management standards become titular and the operating is performed while relying on the wisdom of the field site, so that a less-skilled person cannot implement the stable operating. In contrast, the data processing system 100 according to the present embodiment is configured to classify the performance data based on the determination result as to whether the operation data complies with the management standards for the management parameters and the evaluation characteristics, and to output the classification result. Thereby, according to the data processing system 100 of the present embodiment, it is possible to enable the user to recognize the relationship between whether the management standard is complied with and the evaluation characteristics.

In addition, the data processing system 100 of the present embodiment is configured to classify the performance data into at least four, depending on whether the operation data complies with the management standards for all items relating to the operating parameters among the management parameters, and whether the evaluation data meets the predetermined standard, and to display each frequency as a graph. Thereby, according to the data processing system 100 of the present embodiment, it is possible to enable the user to recognize the occurrence frequency of each classification.

Further, the data processing system 100 of the present embodiment is configured to classify the performance data, depending on whether the evaluation data meets the predetermined standard, for each of the case where the operation data complies with the management standard, the case where the operation data deviates upward from the management standard and the case where the operation data deviates downward from the management standard, for each item of the management parameters, and to display each frequency of each case as a graph. Thereby, according to the data processing system 100 of the present embodiment, it is possible to enable the user to understand the relationship between whether the management standard of each management parameter is complied with and the evaluation characteristics, during the flow of operating.

Furthermore, the data processing system 100 of the present embodiment is configured to output the display screen for showing an association as to which of the cases data, in which the evaluation data does not meet the predetermined standard, corresponds to, for each item of the management parameter. Thereby, according to the data processing system 100 of the present embodiment, it is possible to support the user to estimate the cause that leads to the poor evaluation characteristics.

Furthermore, the data processing system 100 of the present embodiment is configured to output the display screen for showing an association as to which of the cases data, in which the evaluation data meets the predetermined standard, corresponds to, for each item of the management parameter. Thereby, according to the data processing system 100 of the present embodiment, it is possible to support the user to find out the method of adjusting the operating parameter so as to improve the evaluation characteristics.

In addition, the data processing system 100 of the present embodiment comprises the standard update unit configured to update at least one of the evaluation standard or the management standard, and is configured to reclassify the performance data by using the standard after update, as at least one of the evaluation standard or the management standard is updated based on the user input, and to output the reclassified classification result. Thereby, according to the data processing system 100 of the present embodiment, it is possible to enable the user to recognize what evaluation characteristics are expected if the standard is updated, before working on the full-scale improvement.

Further, the data processing system 100 of the present embodiment is configured to use, as the evaluation data, data obtained by evaluating at least one of the quality of the product, or the productivity, cost, delivery and safety of production. Thereby, according to the data processing system 100 of the present embodiment, it is possible to support the stable implementation of PQCDS.

Thereby, according to the data processing system 100 of the present embodiment, it is possible to find out and solve the problems without advanced data analysis knowledges and skills. Also, according to the data processing system 100 of the present embodiment, it is possible to stably implement the PQCDS by supporting the continuous update of the evaluation standard and the management standard, when the operating is performed while complying with the management standards.

Note that, in the above descriptions, the case where the user who uses the data processing system 100 updates the evaluation standard and the management standard has been exemplified. However, the present invention is not limited thereto. The data processing system 100 may also be configured to decide and automatically update or suggest the evaluation standard and the management standard that are to be updated by the data processing system 100.

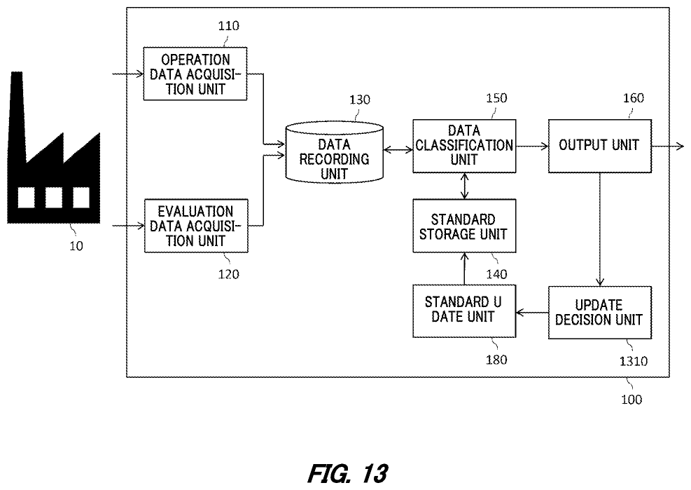

FIG. 13 shows an example of a block diagram of the data processing system 100 according to a modified embodiment of the present embodiment. In FIG. 13, the members having the same functions and configurations as those in FIG. 1 are denoted with the same reference signs, and the descriptions thereof are omitted, except differences to be described below. The data processing system 100 according to the present modified embodiment comprises an update decision unit 1310. Note that, in FIG. 13, the case where the data processing system 100 comprises the update decision unit 1310, instead of the input unit 170 is shows as an example. However, the present invention is not limited thereto. The data processing system 100 may comprise the update decision unit 1310, in addition to the input unit 170. Specifically, the data processing system 100 may comprise both a function of updating a standard, in response to a user input, and a function of automatically updating a standard.

In the present modified embodiment, the output unit 160 is configured to supply the classification result classified by the data classification unit 150 to the update decision unit 1310. The update decision unit 1310 is configured to decide an update of at least one of the evaluation standard or the management standard, according to the classification result output by the output unit 160. The update decision unit 1310 is configured to supply the updated information decided for at least one of the evaluation standard or the management standard to the standard update unit 180. The standard update unit 180 is configured to update at least one of the evaluation standard or the management standard stored in the standard storage unit 140, according to the updated information supplied from the update decision unit 1310. Specifically, the standard update unit 180 is configured to update at least one of the evaluation standard or the management standard, based on the decision made by the update decision unit 1310.

For example, when compressing the evaluation standard range in step 910, the update decision unit 1310 may decide the favorable quality standard range after update, based on the frequency distribution of measured values. As an example, the update decision unit 1310 may decide the favorable quality standard range after update so that a measured value becomes ‘Good’ to ‘Bad’ within a range in which a deviation from an average on the frequency distribution of measured values is equal to or greater than a predetermined threshold (for example, 1σ or greater), based on the histogram shown in FIG. 10. In this way, in the data processing system 100 of the present modified embodiment, the update decision unit 1310 can automatically decide the update of the evaluation standard, according to the classification result.

In addition, for example, when finding out the separation and/or disparity of favorable/poor in step 940, the update decision unit 1310 may use a decision tree analysis. As an example, the update decision unit 1310 may show which parameter is to be used and which value is to be divided for determining the product quality (Good/Bad) by executing the decision tree analysis with the performance data (table format data) as an input. In step 950, the update decision unit 1310 may decide the management standard range after update, based on the analysis result.

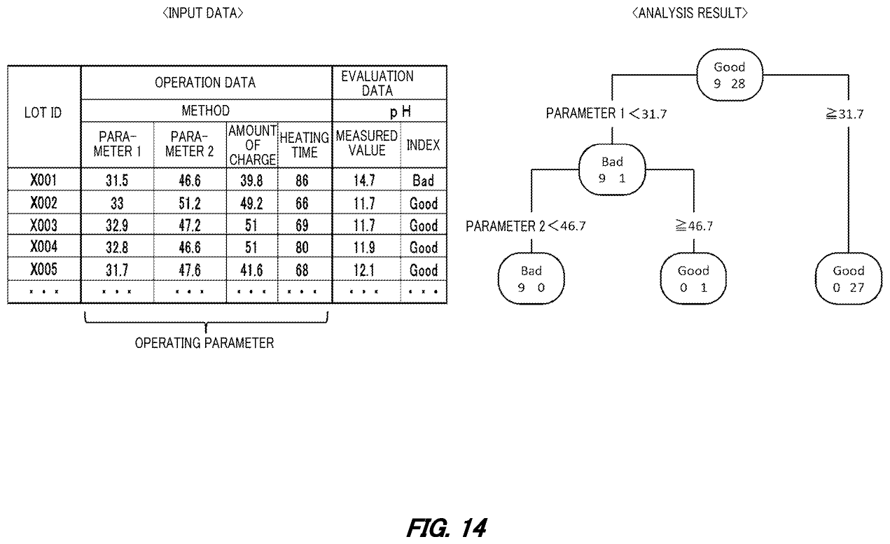

FIG. 14 shows an example of an analysis result when the data processing system 100 according to the modified embodiment of the present embodiment compresses the management standard range by using a decision tree analysis. The update decision unit 1310 is configured to input table format data including a lot ID, performance values of the operating parameters in the lot, and quality evaluation values in the lot, as shown on the left of FIG. 14. The update decision unit 1310 is configured to output an analysis result as shown on the right of FIG. 14 by using the table format data as an input.

On the right of FIG. 14, it is shown how to evaluate 37 lots of the product X as Good and Bad. Specifically, the right of FIG. 14 shows that in a case of parameter 1≥31.7, 27 lots are evaluated as Good, in a case of parameter 1<31.7 and parameter 2≥46.7, one lot is evaluated as Good, and in a case of parameter 1<31.7 and parameter 2<46.7, 9 lots are evaluated as Good. When analyzed in this way, the update decision unit 1310 decides parameter 1≥31.7 and/or parameter 2≥46.7, for example, as the management standard range after update. In this way, in the data processing system 100 of the present modified embodiment, the update decision unit 1310 can automatically decide the update of the management standard, according to the classification result.

In addition, for example, when finding out a deviation pattern in step 970, the update decision unit 1310 may automatically find out a deviation pattern. As an example, in FIG. 7, the update decision unit 1310 may decide a pass having the larger number of associated lots, as the deviation pattern. At this time, for example, the update decision unit 1310 may decide a pass having the largest number of associated lots, as the deviation pattern. Instead of this, the update decision unit 1310 may decide a pass having the n^{th} largest number of associated lots, as the deviation pattern, a pass having the number of associated lots equal to or larger than a predetermined threshold value, as the deviation pattern, or all found passes, as the deviation pattern.

In step 980, the update decision unit 1310 may select a deviation point in the decided deviation pattern, and in FIG. 8, search for the pass having the largest number of associated lots and automatically find out a recovery method. Specifically, the update decision unit 1310 may search for a combination in which the evaluation data highly frequently meets the predetermined standard, from combinations of each case for the plurality of items of the management parameter, and decide the management standard after update. In this way, in the data processing system 100 of the present modified embodiment, the update decision unit 1310 may automatically decide the update of the management standard, according to the classification result.

Like this, the data processing system 100 according to the present modified embodiment further comprises the update decision unit 1310 configured to decide update of at least one of the evaluation standard or the management standard, according to the classification result, and the standard update unit 180 is configured to update at least one of the evaluation standard or the management standard, based on the decision of the update decision unit 1310. Thereby, according to the data processing system 100 of the present modified embodiment, it is possible to automatically optimize the evaluation standard and the management standard that are used when classifying the performance data.

In addition, in the data processing system 100 of the present modified embodiment, the update decision unit 1310 searches for a combination in which the evaluation data highly frequently meets the predetermined standard, from combinations of each case for the plurality of items of the management parameter, and decides the management standard after update. Thereby, according to the data processing system 100 of the present modified embodiment, it is possible to automatically find out the recovery method and to optimize the management standard.

Various embodiments of the present invention may be described with reference to flowcharts and block diagrams whose blocks may represent (1) steps of processes in which operations are performed or (2) sections of devices responsible for performing operations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable media may include an electronic storage medium, a magnetic storage medium, an optical storage medium, an electromagnetic storage medium, a semiconductor storage medium, etc. More specific examples of computer-readable media may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY(registered trademark) disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

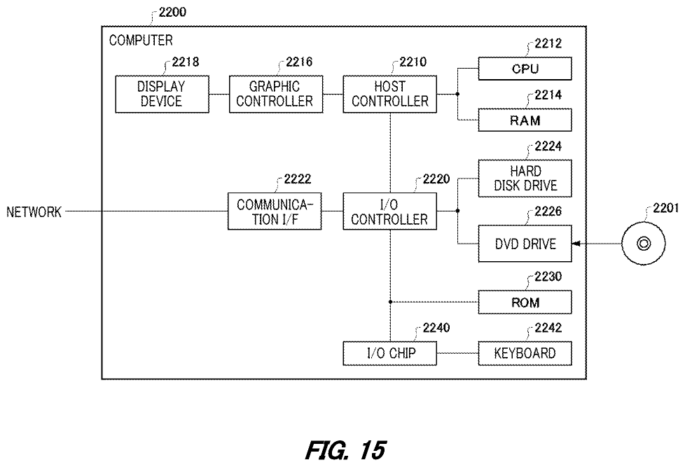

FIG. 15 shows an example of a computer 2200 in which a plurality of aspects of the present invention may be entirely or partially implemented. A program that is installed in the computer 2200 can cause the computer 2200 to function as or execute operations associated with the apparatus of the embodiment of the present invention or one or more sections thereof, and/or cause the computer 2200 to execute the method of the embodiment of the present invention or steps thereof. Such program may be executed by a CPU 2212 so as to cause the computer 2200 to execute certain operations associated with some or all of the blocks of flowcharts and block diagrams described herein.

The computer 2200 according to the present embodiment includes a CPU 2212, a RAM 2214, a graphic controller 2216 and a display device 2218, which are mutually connected by a host controller 2210. The computer 2200 also includes input/output units such as a communication interface 2222, a hard disk drive 2224, a DVD-ROM drive 2226 and an IC card drive, which are connected to the host controller 2210 via an input/output controller 2220. The computer 2200 also includes legacy input/output units such as a ROM 2230 and a keyboard 2242, which are connected to the input/output controller 2220 via an input/output chip 2240.

The CPU 2212 is configured to operate according to programs stored in the ROM 2230 and the RAM 2214, thereby controlling each unit. The graphic controller 2216 is configured to acquire image data generated by the CPU 2212 on a frame buffer or the like provided in the RAM 2214 or in itself, and to cause the image data to be displayed on the display device 2218.

The communication interface 2222 is configured to communicate with other electronic devices via a network. The hard disk drive 2224 is configured to store programs and data used by the CPU 2212 within the computer 2200. The DVD-ROM drive 2226 is configured to read the programs or the data from the DVD-ROM 2201, and to provide the hard disk drive 2224 with the programs or the data via the RAM 2214. The IC card drive is configured to read programs and data from an IC card, and/or to write programs and data into the IC card.

The ROM 2230 is configured to store therein a boot program or the like that is executed by the computer 2200 at the time of activation, and/or a program depending on the hardware of the computer 2200. The input/output chip 2240 may also be configured to connect various input/output units to the input/output controller 2220 via a parallel port, a serial port, a keyboard port, a mouse port and the like.

A program is provided by a computer-readable medium such as the DVD-ROM 2201 or the IC card. The program is read from the computer-readable medium, is installed into the hard disk drive 2224, the RAM 2214 or the ROM 2230, which are also examples of the computer-readable medium, and is executed by the CPU 2212. The information processing described in these programs is read into the computer 2200, resulting in cooperation between a program and the above-mentioned various types of hardware resources. A device or method may be constituted by realizing the operation or processing of information in accordance with the usage of the computer 2200.

For example, when communication is performed between the computer 2200 and an external device, the CPU 2212 may execute a communication program loaded onto the RAM 2214 to instruct communication processing to the communication interface 2222, based on the processing described in the communication program. The communication interface 2222, under control of the CPU 2212, reads transmission data stored on a transmission buffer processing region provided in a recording medium such as the RAM 2214, the hard disk drive 2224, the DVD-ROM 2201, or the IC card, and transmits the read transmission data to a network or writes reception data received from a network to a reception buffer processing region or the like provided on the recording medium.

In addition, the CPU 2212 may be configured to cause all or a necessary portion of a file or a database, which has been stored in an external recording medium such as the hard disk drive 2224, the DVD-ROM drive 2226 (DVD-ROM 2201), the IC card and the like, to be read into the RAM 2214, thereby executing various types of processing on the data on the RAM 2214. The CPU 2212 is configured to write back the processed data to the external recording medium.

Various types of information, such as various types of programs, data, tables, and databases, may be stored in the recording medium to undergo information processing. The CPU 2212 may also be configured to execute various types of processing on the data read from the RAM 2214, which includes various types of operations, processing of information, condition judging, conditional branching, unconditional branching, search/replacement of information and the like described in the present disclosure and designated by an instruction sequence of programs, and to write the result back to the RAM 2214. The CPU 2212 may also be configured to search for information in a file, a database, etc., in the recording medium. For example, when a plurality of entries, each having an attribute value of a first attribute associated with an attribute value of a second attribute, is stored in the recording medium, the CPU 2212 may search for an entry matching the condition whose attribute value of the first attribute is designated, from the plurality of entries, and read the attribute value of the second attribute stored in the entry, thereby obtaining the attribute value of the second attribute associated with the first attribute satisfying the predetermined condition.

The above-described program or software modules may be stored in the computer-readable medium on or near the computer 2200. In addition, a recording medium such as a hard disk or a RAM provided in a server system connected to a dedicated communication network or the Internet can be used as the computer-readable medium, thereby providing the programs to the computer 2200 via the network.

While the embodiments of the present invention have been described, the technical scope of the invention is not limited to the above described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: production management target; 100: data processing system; 110: operation data acquisition unit; 120: evaluation data acquisition unit; 130: data recording unit; 140: standard storage unit; 150: data classification unit; 160: output unit; 170: input unit; 180: standard update unit; 1310: update decision unit; 2200: computer; 2201: DVD-ROM; 2210: host controller; 2212: CPU; 2214: RAM; 2216: graphic controller; 2218: display device; 2220: input/output controller; 2222: communication interface; 2224: hard disk drive; 2226: DVD-ROM drive; 2230: ROM; 2240: input/output chip; 2242: keyboard

What is claimed is:

1. A data processing system comprising:
an operation data acquisition unit configured to acquire operation data indicative of performance relating to an operation of production;
an evaluation data acquisition unit configured to acquire evaluation data indicative of performance relating to an evaluation of the production;
a standard storage unit configured to store each management standard to be complied with for a target management parameter;
a data classification unit configured to classify performance data indicative of performance of the production, based on a determination result obtained by determining whether the operation data complies with the management standard for the management parameter, and the evaluation data; and
an output unit configured to output a classification result.

2. The data processing system according to claim 1, wherein
the data classification unit is configured to classify the performance data into at least four, depending on whether the operation data complies with the management standard for all items relating to an operating parameter of the management parameter, and whether the evaluation data meets a predetermined standard.

3. The data processing system according to claim 2, wherein
the output unit is configured to output a display screen for displaying each frequency classified into the at least four, as a graph.

4. The data processing system according to claim 1, wherein
the data classification unit is configured to classify the performance data, depending on whether the evaluation data meets a predetermined standard, for each of a case where the operation data complies with the management standard, a case where the operation data deviates upward from the management standard and a case where the operation data deviates downward from the management standard, for each item of the management parameter.

5. The data processing system according to claim 2, wherein
the data classification unit is configured to classify the performance data, depending on whether the evaluation data meets a predetermined standard, for each of a case where the operation data complies with the management standard, a case where the operation data deviates upward from the management standard and a case where the operation data deviates downward from the management standard, for each item of the management parameter.

6. The data processing system according to claim 4, wherein
the output unit is configured to output a display screen for displaying a frequency as to whether the evaluation data meets the predetermined standard for each case, for each item of the management parameter, as a graph.

7. The data processing system according to claim 4, wherein
the output unit is configured to output a display screen for showing an association as to which of the cases that data, in which the evaluation data does not meet the predetermined standard, of the performance data corresponds to, for each item of the management parameter.

8. The data processing system according to claim 6, wherein
the output unit is configured to output a display screen for showing an association showing which of the cases that data, in which the evaluation data does not meet the predetermined standard, of the performance data corresponds to, for each item of the management parameter.

9. The data processing system according to claim 4, wherein
the output unit is configured to output a display screen for showing an association as to which of the cases that data, in which the evaluation data meets the predetermined standard, of the performance data corresponds to, for each item of the management parameter.

10. The data processing system according to claim 6, wherein
the output unit is configured to output a display screen for showing an association as to which of the cases that data, in which the evaluation data meets the predetermined standard, of the performance data corresponds to, for each item of the management parameter.

11. The data processing system according to claim 1, further comprising a standard update unit configured to update at least one of an evaluation standard for determining an evaluation index based on the evaluation data, or the management standard.

12. The data processing system according to claim 2, further comprising a standard update unit configured to update at least one of an evaluation standard for determining an evaluation index based on the evaluation data, or the management standard.

13. The data processing system according to claim 11, wherein
the data classification unit is configured to reclassify the performance data by using the standard after update, in response to the update of at least one of the evaluation standard or the management standard, and
the output unit is configured to output a reclassified classification result.

14. The data processing system according to claim 11, further comprising an input unit configured to receive a user input,
wherein the standard update unit is configured to update at least one of the evaluation standard or the management standard, based on the user input.

15. The data processing system according to claim 11, further comprising an update decision unit configured to decide an update of at least one of the evaluation standard or the management standard, according to the classification result,
wherein the standard update unit is configured to update at least one of the evaluation standard and the management standard, based on the decision of the update decision unit.

16. The data processing system according to claim 15, wherein
the update decision unit is configured to search for a combination in which the evaluation data highly frequently meets a predetermined standard, from combinations of each case for a plurality of items of the management parameter, and to decide the management standard after update.

17. The data processing system according to claim 1, wherein
the evaluation data includes data obtained by evaluating a quality of a product to be produced.

18. The data processing system according to claim 1, wherein
the evaluation data includes data obtained by evaluating at least one of productivity, cost, delivery or safety of the production.

19. A data processing method comprising:
acquiring operation data indicative of performance relating to an operation of production;
acquiring evaluation data indicative of performance relating to an evaluation of the production;
storing each management standard to be complied with for a target management parameter;
classifying performance data indicative of performance of the production, based on a determination result obtained by determining whether the operation data complies with the management standard for the management parameter, and the evaluation data; and
outputting a classification result.

20. A recording medium having a data processing program recorded thereon configured to be executed by a computer and to cause the computer to function as:
an operation data acquisition unit configured to acquire operation data indicative of performance relating to an operation of production;
an evaluation data acquisition unit configured to acquire evaluation data indicative of performance relating to an evaluation of the production;
a standard storage unit configured to store each management standard to be complied with for a target management parameter;
a data classification unit configured to classify performance data indicative of performance of the production, based on a determination result obtained by determining whether the operation data complies with the management standard for the management parameter, and the evaluation data; and
an output unit configured to output a classification result.
